(19) United States
(12) Patent Application Publication
(10) Pub. No.: US 2015/0266420 A1
(43) Pub. Date: Sep. 24, 2015

(54) SYSTEMS AND METHODS FOR CONTROLLING A VEHICLE DISPLAY

(71) Applicants: David Bryant, Dublin, OH (US); Troy Thompson, Marysville, OH (US)

(72) Inventors: David Bryant, Dublin, OH (US); Troy Thompson, Marysville, OH (US)

(73) Assignee: HONDA MOTOR CO., LTD., Tokyo (JP)

(21) Appl. No.: 14/220,589

(22) Filed: Mar. 20, 2014

(51) Int. Cl. B60Q 9/00; H04N 7/18

(52) U.S. Cl. CPC B60Q 9/008; H04N 7/183

(57) ABSTRACT

A system for use in displaying at least one image of an area external to a vehicle is provided. The system includes a sensor, at least one exterior camera configured to capture at least one image of the area external to the vehicle, a display device, and a computing device coupled to the sensor, to the at least one exterior camera, and to the display device. The computing device is configured to detect at least one of a presence of a hand within a predefined range of a shifting device, a contact between the hand and a steering wheel, and an activation of a brake pedal, based on a signal received from the sensor, and display, in response to detecting at least one of the presence, the contact, and the activation, at least one image from the at least one exterior camera on the display device.

### BACKGROUND

At least some known vehicles include a display device on the dashboard that displays one or more images, for example a video feed, from an exterior camera mounted to the vehicle. For example, the display device may present one or more images from a rear-view exterior camera of the vehicle. In such vehicles, one or more images from the exterior camera are displayed on the display device after the driver activates a switch or moves a shifting device of the vehicle from a first mode (e.g., park) to a second mode (e.g., reverse). In some such vehicles, the vehicle may already be moving in the second mode (e.g., moving in reverse) by the time the driver is notified of the presence of an object external to the vehicle.

### BRIEF DESCRIPTION

In one aspect, a system for use in displaying at least one image of an area external to a vehicle is provided. The system includes a sensor mounted to the vehicle, at least one exterior camera mounted to the vehicle and configured to capture at least one image of the area external to the vehicle, a display device mounted to the vehicle, and a computing device coupled to the sensor, to the at least one exterior camera, and to the display device. The computing device is configured to detect at least one of a presence of a hand within a predefined range of a shifting device in the vehicle, a contact between the hand and a steering wheel in the vehicle, and an activation of a brake pedal in the vehicle, based on a signal received from the sensor, and display, in response to detecting at least one of the presence of the hand, the contact between the hand and the steering wheel, and the activation of the brake pedal, at least one image from the at least one exterior camera on the display device.

In another aspect, a method for displaying at least one image of an area external to a vehicle is provided. The method includes detecting, by a computing device coupled to a sensor mounted to the vehicle, a presence of a hand within a predefined range of a shifting device in the vehicle, based on a signal received from the sensor. The method additionally includes displaying, in response to detecting the presence of the hand, at least one image from at least one exterior camera mounted to the vehicle on a display device mounted to the vehicle.

In another aspect, a computer-readable storage device having processor-executable instructions embodied thereon is provided. The processor-executable instructions are for displaying at least one image of an area external to a vehicle. When executed by a computing device communicatively coupled to a sensor mounted to the vehicle, to at least one exterior camera mounted to the vehicle, and to a display device mounted to the vehicle, the processor-executable instructions cause the computing device to detect a presence of a hand within a predefined range of a shifting device in the vehicle, based on a signal received from the sensor, and display, in response to detecting the presence of the hand, at least one image from the at least one exterior camera on the display device.

In another aspect, a system for use in presenting an alert within a vehicle based on at least one condition exterior to the vehicle is provided. The system includes a first sensor mounted in an interior of the vehicle, a second sensor configured to monitor an area external to the vehicle, and a computing device coupled to the first sensor and to the second sensor. The computing device is configured to detect at least one of a presence of a hand within a predefined range of a shifting device in the vehicle, a contact between the hand and a steering wheel in the vehicle, and an activation of a brake pedal in the vehicle, based on a first signal received from the first sensor. The computing device is additionally configured to determine, based on a second signal received from the second sensor, if an object is positioned within a predefined distance from the vehicle, and provide, in response to detecting at least one of the presence, the contact, and the activation, and determining that the object is positioned within the predefined distance of the vehicle, an alert indicating the presence of the object.

### BRIEF DESCRIPTION OF THE DRAWINGS

FIG. 1 is a diagram of an example vehicle containing an exemplary system for use in alerting a driver of the presence of an object external to vehicle.

FIG. 2 is a schematic diagram of a hand of a driver within a predefined range of a shifting device that may be included in the vehicle shown in FIG. 1.

FIG. 3 is a block diagram of an exemplary computing device that may be included in the vehicle shown in FIG. 1.

FIG. 4 is a flow chart of an exemplary process that may be implemented by the system shown in FIG. 1 to display at least one image captured by an exterior camera.

FIG. 5 is a flow chart of an exemplary process that may be implemented by the system of FIG. 1 to present an alert within the vehicle based on at least one condition exterior to the vehicle.

### DETAILED DESCRIPTION

Implementations of methods and systems described herein facilitate alerting a driver of the presence of an object external to a vehicle. Systems described herein include a sensor configured to monitor an area external to a vehicle and a computing device configured to alert a driver as to the presence of the object. Moreover, implementations of systems and methods described herein include detecting a presence of a driver's hand within a predefined range of a shifting device in the vehicle, detecting contact between the driver's hand and a steering wheel in the vehicle, and/or detecting activation of a pedal, such as a brake pedal, in the vehicle. When the driver's hand is within the predefined range of the shifting device or in contact with the steering wheel, or if the pedal is activated, the system produces an alert indicating the presence of the object external to the vehicle. For example, the alert may be a visual indication of the area in which the object is located, one or more images from one or more external cameras (i.e., sensors) mounted to the vehicle displayed on a display device mounted to the vehicle, and/or an audible alert of the presence of the object. Accordingly, before the driver shifts the vehicle into reverse, for example, the system alerts the driver of any objects external to the vehicle. In some implementations, the predefined range may be configured by a manufacturer before the vehicle is provided to the driver. Additionally, in some implementations, the driver or another user may configure the predefined range, for example through a user interface displayed on the display device.

Additionally, in some implementations in which the vehicle includes multiple exterior cameras, for example a front-view exterior camera, a rear-view exterior camera, a driver-side exterior camera, and/or a passenger-side exterior camera, images captured by the cameras and that will be displayed on the display device may be predefined, for example by the manufacturer or through a user interface presented on the display device. In other implementations, a computing device detects the presence of an object within a predefined distance of the vehicle and causes images captured by the corresponding exterior camera to be displayed on the display device when the hand of the driver is within the predefined range of the shifting device. Accordingly, the implementations described herein facilitate alerting a driver as to the presence of an object external to the vehicle before the vehicle has been transitioned from a first mode (e.g., park) to a second mode (e.g., reverse).

In at least one implementation, a computer program is provided, and the program is embodied on a computer-readable medium. The program is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded with the word “a” or “an” should be understood as not excluding plural elements or steps, unless such exclusion is explicitly recited. Furthermore, references to “example implementation” or “one implementation” of the present disclosure are not intended to be interpreted as excluding the existence of additional implementations that also incorporate the recited features.

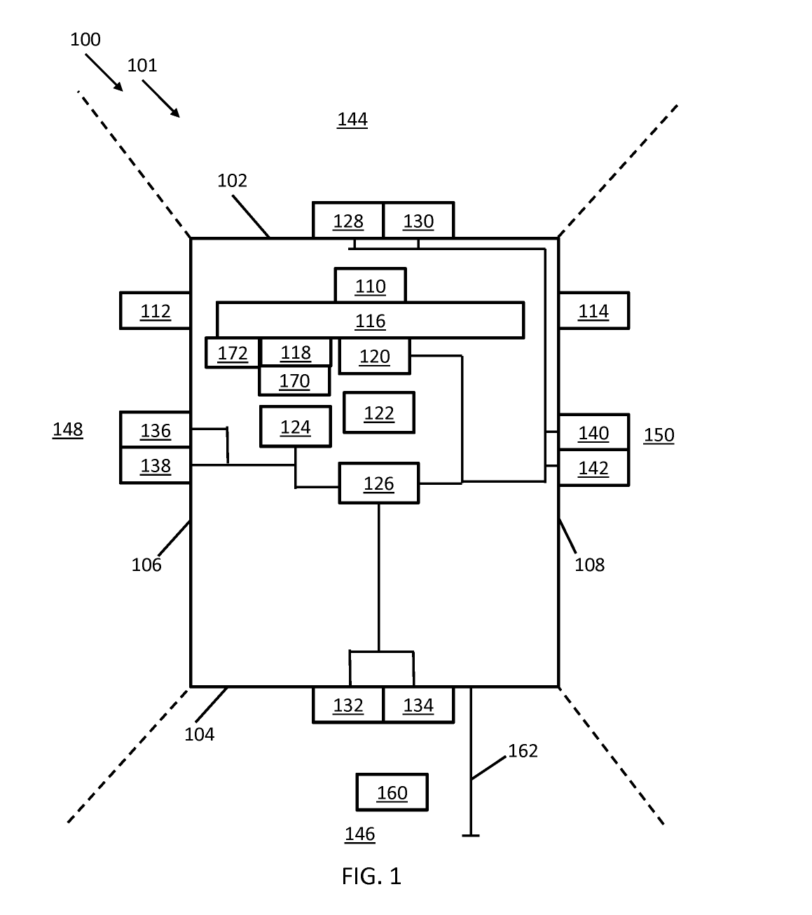

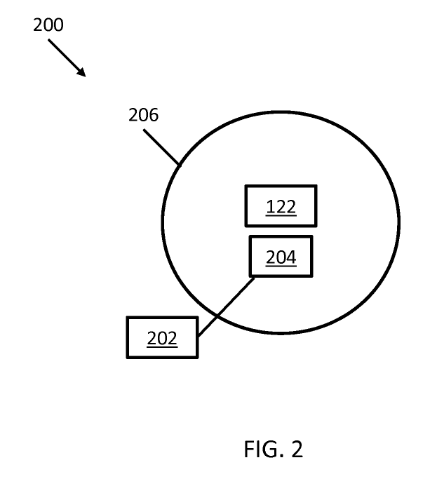

FIG. 1 is a diagram of an example vehicle 100 containing an exemplary system 101 for use in alerting a driver of the presence of an object external to vehicle 100. In the exemplary embodiment, vehicle 100 includes a front portion 102, a rear portion 104, a driver-side portion 106, and a passenger-side portion 108. Additionally, vehicle 100 includes a rear-view mirror 110, a driver-side mirror 112, and a passenger-side mirror 114. Vehicle 100 also includes a dashboard 116 and an instrument panel 118. Moreover, vehicle 100 includes a display device 120 that may be mounted to dashboard 116. In other implementations, display device 120 may be mounted to instrument panel 118. In yet other implementations, display device 120 may be mounted to any other portion of vehicle 100, including rear-view mirror 110, driver-side mirror 112, and/or passenger-side mirror 114. As used herein, the term “mounted to” should be understood to mean mounted to an external portion or to an internal portion (i.e., mounted within) another component (e.g., vehicle 100). Additionally, vehicle 100 includes a shifting device 122 that enables a driver 202 (FIG. 2) to select a mode or gear for vehicle 100 to operate in. For example, shifting device 122 may be operated to select a drive mode, a park mode, a neutral mode, a reverse mode, and/or other modes or gears for vehicle 100 to operate in. Moreover, shifting device 122 may include a shift lever, button(s), dial(s), and/or any other device that allows driver 202 to select a mode or gear in which vehicle 100 operates. Vehicle 100 also includes a steering wheel 170 and at least one pedal 172, for example a brake pedal, a clutch pedal, and/or an accelerator pedal.

Vehicle 100 also includes a sensor 124 that is coupled to a computing device 126. Sensor 124 may be, for example a visual sensor, such as a camera, or a proximity sensor, such as a capacitive sensor. Sensor 124 may also be or include a switch and/or a pressure sensor. Sensor 124 transmits a signal corresponding to data, for example visual data (e.g., image data or video data), proximity data, pressure data, and/or activation data to computing device 126. Computing device 126 receives the signal from sensor 124 and determines whether a hand 204 (FIG. 2) of driver 202 (FIG. 2) is within a predefined range 206 (FIG. 2) of shifting device 122, as is discussed in more detail herein, and/or whether hand 204 is in contact with steering wheel 170, and/or whether pedal 172 is depressed (e.g., pressure has been applied to the pedal). A front-view exterior sensor 128, a front proximity sensor 130, a rear-view exterior sensor 132, a rear proximity sensor 134, a driver-side exterior sensor 136, a driver-side proximity sensor 138, a passenger-side exterior sensor 140, and a passenger-side proximity sensor 142 are also each coupled to computing device 126. Each exterior sensor 128, 132, 136 and 140, and proximity sensor 130, 134, 138 and 142 is also mounted to vehicle 100. In some implementations, one or more of exterior sensors 128, 132, 136, and 140 includes an image sensor or camera.

In some implementations, front-view exterior sensor 128 transmits a signal corresponding to sensor data, for example visual data (e.g., video data or image data) pertaining to a front area 144 to computing device 126. Likewise, rear-view exterior sensor 132 transmits a signal corresponding to sensor data pertaining to a rear area 146 to computing device 126. Additionally, driver-side exterior sensor 136 transmits a signal corresponding to sensor data pertaining to a driver-side area 148 to computing device 126, and passenger-side exterior sensor 140 transmits a signal corresponding to sensor data pertaining to a passenger-side area 150 to computing device 126. Computing device 126 receives a signal corresponding to proximity data from proximity sensors 130, 134, 138, and 142 and determines whether an object 160 is within a predefined distance 162 of vehicle 100. In some implementations, proximity sensors 130, 134, 138, and 142 are included within exterior sensors 128, 132, 136, and 140, respectively. In yet other implementations, proximity sensors 130, 134, 138, and 142 are absent, and computing device 126 determines whether object 160 is within predefined distance 162 of vehicle 100 based on the one or more signals corresponding to sensor data transmitted from at least one exterior sensor 128, 132, 136, and/or 140 to computing device 126.

In some implementations, system 101, and more specifically computing device 126, is configured to perform object recognition. More specifically, in such implementations, computing device 126 detects or recognizes specific types of objects, such as user-defined or predefined objects, and provides a warning if computing device 126 detects such an object. In some implementations, system 101 may provide different alerts, such as audible alerts and/or visual alerts (e.g., displaying a highlighted area on display device 120 and/or lighting of an indicator light corresponding to a detected object), based on the type of object recognized, the distance of the object to vehicle 100, and/or the area 144, 146, 148, or 150 in which the object is located.

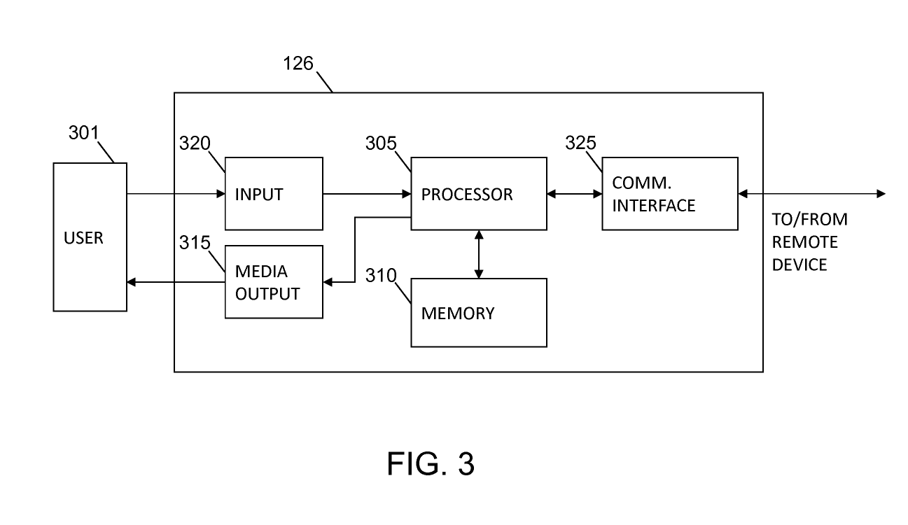

FIG. 2 is a schematic diagram 200 of hand 204 of driver 202 within a predefined range 206 of an internal component of vehicle 100, for example, shifting device 122. Although illustrated as shifting device 122, the internal component may include, but is not limited to, steering wheel 170 and/or brake pedal 172. As described with reference to FIG. 1, sensor 124 transmits data (e.g., a signal corresponding to a distance between hand 204 and shifting device 122) to computing device 126 and computing device 126 determines whether hand 204 is within predefined range 206 of shifting device 122. For example, sensor 124 may be a camera mounted above shifting device 122, such that sensor 124 transmits a top-down image of shifting device 122 and hand 204 to computing device 126. In other implementations, sensor 124 may be mounted to a different location in vehicle 100, including for example, to shifting device 122 or to dashboard 116. In some implementations, predefined range 206 may be selectively configured by driver 202 through a user interface (not shown) on display device 120. In other implementations, predefined range 206 may be configured by a manufacturer or service center. Predefined range 206 may be stored in a memory area 310 (FIG. 3) of computing device 126. Examples of predefined range 206 include, but are not limited to, approximately six inches from shifting device 122, approximately three inches from shifting device 122, and also may include zero inches (i.e., contact between driver's hand 204 and shifting device 122).

In some implementations, when hand 204 is within predefined range 206 of shifting device 122, computing device 126 causes one or more images of areas 144, 146, 148, and 150 to be displayed on display device 120. In some implementations, computing device 126 determines that vehicle 100 is in park before causing display device 120 to display one or more images of areas 144, 146, 148, and 150. In some implementations, computing device 126 causes display device 120 to display an image according to a predefined setting. For example, memory area 310 (shown in FIG. 3) of computing device 126 may include a predefined setting to display rear area 146 when hand 204 is within predefined range 206. In some implementations, the predefined setting may be specified by driver 202, for example through a user interface (not shown), or by the manufacturer or service center.

In some implementations, when object 160 is within predefined distance 162 of one or more of portions 102, 104, 106, or 108, computing device 126 causes display device 120 to display one or more images of corresponding areas 144, 146, 148, and 150. By displaying one or more images of areas 144, 146, 148, and 150 when hand 204 enters predefined range 206, system 100 may warn driver 202 of the presence of object 160 before vehicle 100 begins moving towards object 160. In other implementations, sensor 118 detects proximity or contact between hand 204 and steering wheel 270 and/or the activation (e.g., depression) of pedal 172 and alerts driver 202 as to the presence and/or location of object 160 through a visual and/or audible alert.

As an alternative to, or in combination with, displaying images or video of an area external to vehicle 100, computing device 126 may cause illumination of a visual indicator within vehicle 100 and/or cause display device 120 to display an icon, colors, or other indication of where object 160 is located. In other implementations, computing device 126 causes an audible alert, such as a tone or voice indicating the presence and location of object 160 to be output through a media output component 315 (FIG. 3).

FIG. 3 is a block diagram of an exemplary computing device 126. In the exemplary implementation, computing device 126 includes a processor 305 for executing instructions. In some implementations, executable instructions are stored in a memory area 310. Processor 305 may include one or more processing units (e.g., in a multi-core configuration). Memory area 310 is any device allowing information such as executable instructions and/or other data to be stored and retrieved. Memory area 310 may include one or more computer-readable media.

Computing device 126 also includes at least one media output component 315 for presenting information to user 301 (e.g., driver 202). Media output component 315 is any component capable of conveying information to user 301. In some embodiments, media output component 315 includes an output adapter such as a video adapter and/or an audio adapter. An output adapter is operatively coupled to processor 305 and operatively couplable to an output device such as a display device (e.g., a liquid crystal display (LCD), organic light emitting diode (OLED) display, cathode ray tube (CRT), or “electronic ink” display) such as display device 120 (FIG. 1), or an audio output device (e.g., a speaker or headphones).

In some embodiments, computing device 126 includes an input device 320 for receiving input from user 301. Input device 320 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 315 and input device 320.

Computing device 126 may also include a communication interface 325 that facilitates communication between computing device 126 and at least one remote device. For example, communication interface 325 may include a wired or wireless network adapter or a wireless data transceiver. Communication interface 325 may communicate with, or be included within, a vehicle bus and apply protocols that may include, but are not limited to, controller area network (CAN), local interconnect network (LIN), media oriented systems transport (MOST), IEEE 1394, and/or proprietary protocols.

Stored in memory area 310 are, for example, computer-readable instructions for providing a user interface to user 301 via media output component 315 and, optionally, receiving and processing input from input device 320. Additionally, memory area 310 may store predefined range 206 (FIG. 2), predefined distance 162, and/or a predefined setting for which of areas 144, 146, 148, and 150 to display images of when hand 204 comes within predefined range 206 of shifting device 122, when hand 204 comes into contact with steering wheel 170, and/or when pedal 172 is activated.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

Although illustrated as a single component, the processing devices, memory areas, inputs, and outputs of computing device 126 may be remote from one another yet able to communicate to perform the functions of computing device 126.

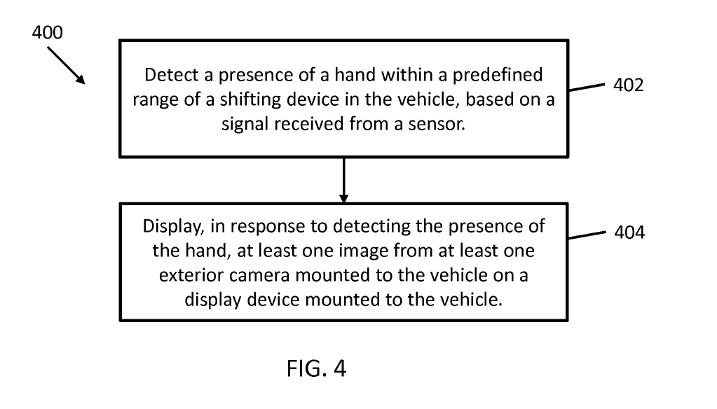

FIG. 4 is a flow chart of an exemplary process 400 that may be implemented by system 101 of FIG. 1 to display at least one image captured by at least one exterior camera 128, 132, 136, and 140. Initially, computing device 126 detects 402 a presence of a hand (e.g., hand 204) within a predefined range (e.g., predefined range 206) of a shifting device (e.g., shifting device 122) in the vehicle (e.g., vehicle 100), based on a signal received from a sensor (e.g., sensor 124) mounted in the vehicle (e.g., vehicle 100). In response to detecting the presence of the hand (e.g., hand 204), computing device 126 displays 404 at least one image from at least one exterior camera (e.g., rear-view exterior sensor 132) mounted to the vehicle (e.g., vehicle 100) on a display device (e.g., display device 120) mounted to the vehicle (e.g., vehicle 100).

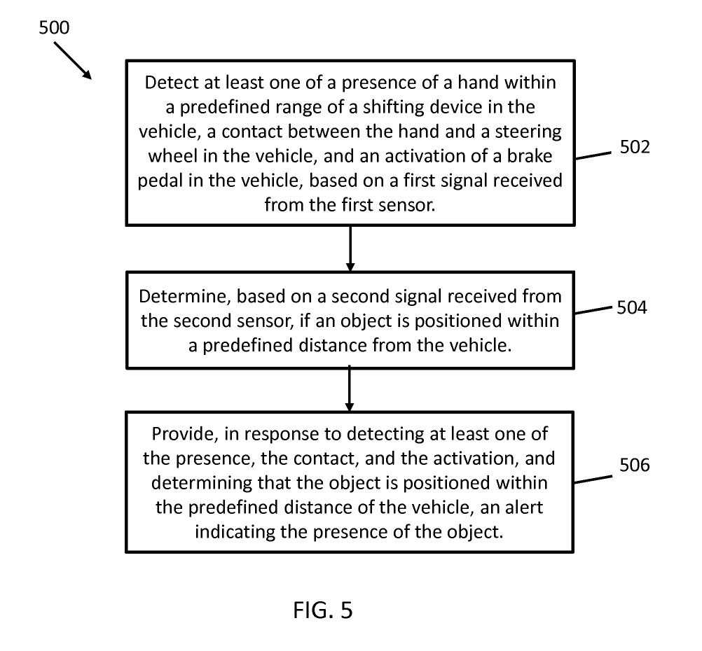

FIG. 5 is a flow chart of an exemplary process 500 that may be implemented by system 101 of FIG. 1 to present an alert within vehicle 100 based on at least one condition exterior to vehicle 100. Initially, computing device 126 detects 502 at least one of a presence of hand 204 within predefined range 206 of shifting device 122 in vehicle 100, a contact between hand 204 and steering wheel 170 in vehicle 100, and an activation of brake pedal 172 in vehicle 100, based on a first signal received from a first sensor (e.g., sensor 124). Additionally, computing device 126 determines, based on a second signal received from a second sensor (e.g., rear-view exterior sensor 132), if an object (e.g., object 160) is positioned within predefined distance 162 from vehicle 100. Additionally, computing device 126 provides, in response to detecting at least one of the presence, the contact, and the activation, and determining that object 160 is positioned within predefined distance 162 of vehicle 100, an alert indicating the presence of object 160.

The methods and systems described herein may be implemented using computer programming or engineering techniques including computer software, firmware, hardware or any combination or subset thereof, wherein the technical effect may include at least one of: (a) detecting a presence of a hand within a predefined range of a shifting device in a vehicle based on a signal received from a sensor; (b) displaying, in response to detecting the presence of the hand, at least one image from at least one exterior camera mounted to the vehicle on a display device mounted to the vehicle. The technical effect may also or alternatively include at least one of: (c) detecting at least one of a presence of a hand within a predefined range of a shifting device in a vehicle, a contact between the hand and a steering wheel in the vehicle, and an activation of a brake pedal in the vehicle, based on a first signal received from a first sensor; (d) determining, based on a second signal received from a second sensor, if an object is positioned within a predefined distance from the vehicle; and (e) providing, in response to detecting at least one of the presence, the contact, and the activation, and determining that the object is positioned within the predefined distance of the vehicle, an alert indicating the presence of the object.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 305, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

As compared to known systems and methods for alerting a driver of the presence of an object outside a vehicle, the systems and methods described herein alert the driver of the presence of the object before the vehicle has been transitioned from a first mode (e.g., park) to a second mode (e.g., reverse). Accordingly, the systems and methods described herein may facilitate providing the driver with information about one or more objects exterior to the vehicle more quickly than in known systems.

Exemplary embodiments of systems and methods for alerting a driver of the presence of an object outside a vehicle are described herein. The systems and methods described herein are not limited to the specific embodiments described herein, but rather, components of the systems and/or steps of the methods may be utilized independently and separately from other components and/or steps described herein.

This written description uses examples to provide details on the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for use in displaying at least one image of an area external to a vehicle, said system comprising:
a sensor mounted to the vehicle;
at least one exterior camera mounted to the vehicle and configured to capture at least one image of the area external to the vehicle;
a display device mounted to the vehicle; and
a computing device coupled to said sensor, to said at least one exterior camera, and to said display device, said computing device configured to:
detect at least one of a presence of a hand within a predefined range of a shifting device in the vehicle, a contact between the hand and the steering wheel in the vehicle, and an activation of a brake pedal in the vehicle, based on a signal received from said sensor; and
display, in response to detecting at least one of the presence of the hand, the contact between the hand and the steering wheel, and the activation of the brake pedal, at least one image from said at least one exterior camera on said display device.

2. The system of claim 1, wherein the vehicle includes an instrument panel and said display device is included within the instrument panel.

3. The system of claim 1, wherein the vehicle includes a mirror and said display device is included within the mirror.

4. The system of claim 1, wherein said sensor is at least one of a visual sensor and a proximity sensor configured to generate a signal corresponding to a distance between a hand and the shifting device.

5. The system of claim 1, wherein said at least one camera comprises a rear-view camera configured to capture at least one image of an area behind a rear-portion of the vehicle.

6. The system of claim 1, wherein said at least one camera comprises a plurality of cameras positioned around the vehicle such that images are captured of the area in front of the vehicle, to the sides of the vehicle, and behind the vehicle.

7. The system of claim 6, wherein said computing device is further configured to detect the presence of an object within a predefined distance of the vehicle.

8. The system of claim 7, wherein said computing device is further configured to, in response to detecting at least one of the presence of the hand, the contact between the hand and the steering wheel, and the activation of the brake pedal, display at least one image from the exterior camera of the plurality of exterior cameras pointed in the direction of the detected object.

9. The system of claim 1, wherein said computing device is further configured to determine that the vehicle is in park before displaying the at least one image.

10. A method for displaying at least one image of an area external to a vehicle, said method comprising:
detecting, by a computing device coupled to a sensor mounted to the vehicle, a presence of a hand within a predefined range of a shifting device in the vehicle, based on a signal received from the sensor; and
displaying, in response to detecting the presence of the hand, at least one image from at least one exterior camera mounted to the vehicle on a display device mounted to the vehicle.

11. The method of claim 10, wherein displaying at least one image further comprises displaying at least one image from at least one exterior camera mounted to the vehicle on the display device that is included in an instrument panel of the vehicle, in a dashboard of the vehicle, or in a mirror of the vehicle.

12. The method of claim 10, wherein detecting a presence of a hand further comprises detecting, by the computing device coupled to at least one of a visual sensor and a proximity sensor mounted to the vehicle, a presence of a hand within a predefined range of a shifting device in the vehicle.

13. The method of claim 10, further comprising selecting the area based on a predefined setting that designates a first exterior camera of the at least one exterior camera.

14. The method of claim 10, wherein displaying at least one image further comprises displaying at least one image from a rear-view exterior camera mounted to the vehicle.

15. The method of claim 10, further comprising determining that the vehicle is parked before displaying the at least one image.

16. The method of claim 10, further comprising detecting the presence of an object within a predefined distance of the vehicle.

17. A system for use in presenting an alert within a vehicle based on at least one condition exterior to the vehicle, said system comprising:
a first sensor mounted in an interior of the vehicle;
a second sensor configured to monitor an area external to the vehicle;
a computing device coupled to said first sensor and to said second sensor, said computing device configured to:
detect at least one of a presence of a hand within a predefined range of a shifting device in the vehicle, a contact between the hand and a steering wheel in the vehicle, and an activation of a brake pedal in the vehicle, based on a first signal received from said first sensor;
determine, based on a second signal received from said second sensor, if an object is positioned within a predefined distance from the vehicle; and
provide, in response to detecting at least one of the presence, the contact, and the activation, and determining that the object is positioned within the predefined distance of the vehicle, an alert indicating the presence of the object.

18. The system of claim 17, wherein said computing device is further configured to perform object recognition on the object and to base the alert at least in part on recognition of the object.

19. The system of claim 17, wherein said computing device is further configured to provide a visual alert including a visual indication of the area in which the object is located.

20. The system of claim 17, wherein said computing device is further configured to provide an audible alert indicating the presence of the object.
